(19) United States
(12) Patent Application Publication
(10) Pub. No.: US 2007/0040850 A1
(43) Pub. Date: Feb. 22, 2007

(54) MEDIA DELIVERY SYSTEM AND METHOD

(75) Inventor: Matthew Donald Coleman, Auckland (NZ)

Correspondence Address: DARBY & DARBY P.C., P. O. BOX 5257, NEW YORK, NY, 10150-5257, US

(73) Assignee: TXTStation Global Limited, Auckland (NZ)

(21) Appl. No.: 11/462,441

(22) Filed: Aug. 4, 2006

Related U.S. Application Data
(60) Provisional application No. 60/706,264, filed on Aug. 4, 2005.

(51) Int. Cl. G09G 5/00

(52) U.S. Cl. 345/629

(57) ABSTRACT

An interactive system that provides real time animated broadcast graphics which are input directly from a mobile device. The input from the mobile devices may include text messages and the like. The broadcast graphics are then output by the system to any kind of display screen, such as a television, stadium screen or a mobile device screen. The broadcast graphics may include real time animation in response to the mobile device input. The real time animated graphics are output in broadcast compatible video feed.

This application claims benefit of U.S. Provisional Application No. 60/706,264, filed Aug. 4, 2005, the contents of which are incorporated by reference herein.

### BACKGROUND OF THE INVENTION

1. Field of the Invention

The present invention relates to media delivery, particularly though not solely to dynamic or real time graphic overlays for video signals where the graphic is representative of real time voting.

2. Description of Related Art

It is known in the art to provide statistics via graphic representations for television broadcasts and the like. For example on www.vizrt.com a service is offered including real-time digital graphics, integrated enterprise content management and distribution tools for visual communication. They produce visual content for broadcast graphics, virtual environments and quantitative visualization and information display across networks that are delivered to different media platforms, including television, interactive television, the Internet, and WAP.

On www.yarosa.com a range of SMS games and SMS-TV formats as described.

On www.minick.net a Wireless TV Box may be installed in any TV studio environment and directly generates the TV signal based on a large selection of predefined or custom-built graphical templates.

### SUMMARY OF THE INVENTION

It is therefore an object of the present invention to provide a media delivery system which goes someway to overcoming any disadvantages in the prior art or which will at least provide the public with a useful choice.

Accordingly the present invention may be broadly said to consist in a media delivery system comprising:

a input configured to receive a video signal;

at least one data input configured to receive raw data received from a public communications system;

a processor configured to receive said raw data and said video signal and:
filter said raw data according to predetermined instructions,
calculate statistics relating to said filtered data in real time at least over periods short enough to approximate real time, and
generate a composite signal, having a portion composed of said video signal and a portion comprising a real time graphical representation of at least one of said statistics;

an output configured to provide said composite signal.

Preferably said representation includes an animation dependant on said statistic.

Preferably said raw data includes voting information.

Preferably said voting information comprises a campaign identifier and a vote or other voter input.

Preferably said raw data comprises text messages from a mobile phone operator.

Preferably said raw data is filtered to remove offence language.

Preferably said raw data is filtered to accept incorrectly formatted data.

Preferably said statistics include a tally of the votes for each campaign.

Preferably said statistics include a trend of the votes for each campaign.

Preferably said representation is also varied semi independently of said statistic.

Preferably said semi independent variation is random or noise generated.

Preferably said composite signal further comprises a portion of advertising graphics.

Preferably said advertising graphics are displayed for predetermined periods.

Preferably said advertising graphics are displayed periodically.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE DRAWINGS

Preferred forms of the present invention will now be described with reference to

FIG. 1 is an example filter chain;

FIG. 2 is an example composite video output with graphic overlay on the video;

FIG. 3 is a block diagram of the present invention;

FIG. 4 is a flow diagram of the text messages to screen feature;

FIG. 5 is a flow diagram of the text message voting feature;

FIG. 6 is a class diagram according to the present invention; and

FIG. 7 is a database structure according to the present invention.

### DETAILED DESCRIPTION OF THE PREFERRED EMBODIMENT

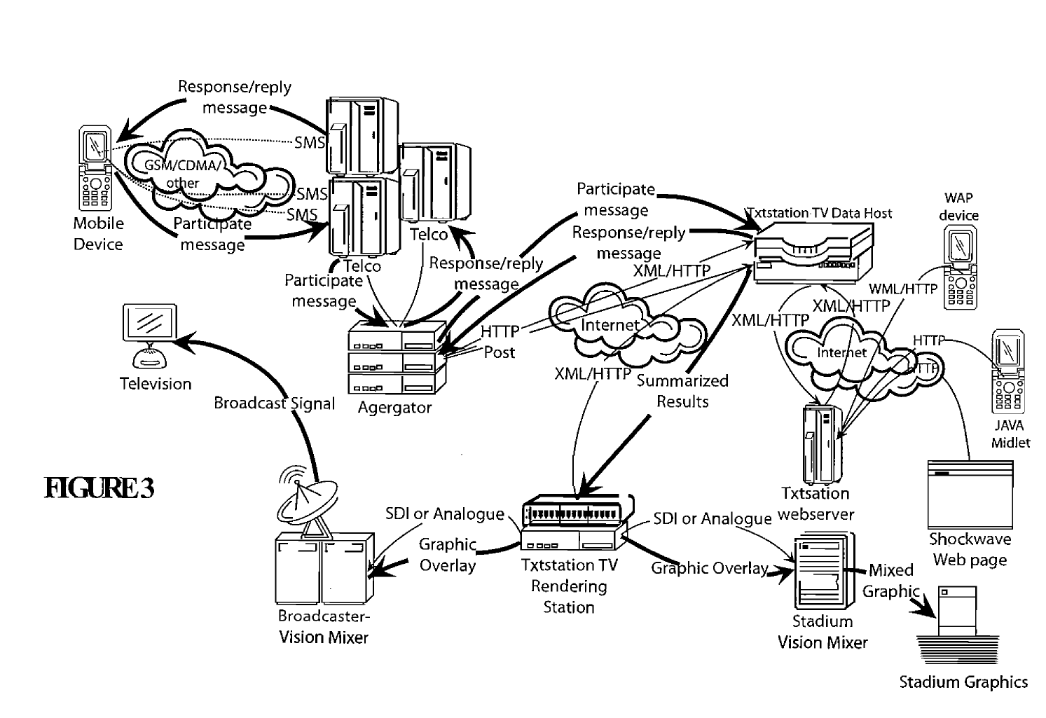

The present invention relates in one embodiment to an interactive system that provides real-time animated broadcast graphics directly from input from mobile devices. As seen in FIG. 3 input is provided from mobile devices 300 includes SMS text messages, WAP, Java midlet etc. The system outputs broadcast graphics to television 302, in stadium screens 304, and dynamic display capable mobile devices 306 etc. The broadcast graphics include real-time animations in response to the mobile device input. Mobile devices input can include Mobile phones, PDA's, and remote internet access etc. The real time animated graphics are output in broadcast compatible video feed.

### Operation

A participant chooses to interact with a promotion and uses his/her mobile phone or other wireless device to send a message to a specified destination. Participants' wireless provider/Telcos (independently) forward messages to the Aggregator 312, which compiles all messages and forwards them on to the TDH 310 which archives and summarizes all messages, providing results accessible by the TRS 308 which then generates real-time graphics and animations for broadcast. The TRS 308 then provides the Broadcaster (for Television, or on-site Events such as Big-Screens in Stadiums) a video signal of the interactive graphics. Additional interactivity and output mediums include Web pages and cell phone applets.

Example throughput statistics of messages to screen can be described in the following ways for voting:
Real-time percentages and animations of percentages.
Trend analysis, i.e. much more fluid animations based on current real-time voting trends with adjustable sample size.

The chain of events are:
Viewer TXTs in.
Telco (Vodafone, Telecom etc) accepts message.
Aggregator gateway replies to messages and creates summary data for us.
Receive aggregated data via XML over the Internet.
Analyze trends, archives TXT messages to scrollers—including censorship and approval, and generates real-time graphics based on this feed.
   Animation

The TV Data Host (TDH) 310 provides the collection and summary from each individual input into a summarized structure format that can be used by the system. The TDH provides the reply messages and responses back to the individual user/participant. One feature to the TDH is the ability to match and categorize input by regular expression e.g. angles 20, ang20, anggels20, angels bob, angbob would all be valid for a single option in a promotion.

Animation of input processing happens in real-time. The TV rendering station (TRS) 308 requests xml input data over a network (internet or private) via the http protocol from the TV data host. The data is requested at subsecond intervals. Animated graphics for broadcast require up to 30 individual frames per second. A feature of the TRS is the ability to create each individual frame from the data, even when not requested from the data host at the frame rate, calculating the change and rendering fill-in frames to provide a smooth animation.

The TRS is the workstation/server that is typically used on site at Broadcaster locations (on site, OB Van, or studios) which actually generates the graphics (fill, key & reference signal) video out to connect to Broadcasters vision mixers and then on subsequently to Big Screen or on-air to TV.

Example Video Out Specifications:

NTSC (720×486 29.97 fps)
PAL (720×576 25 fps)
SDI Digital Video Out
Composite/Component Analogue Video Out
HDTV

The TRS also features the ability to chain noise filters to the input data to provide animation to stationary data i.e. percentages generated from large amounts of voting does not change at a high enough rate to generate noticeable movement - applying noise filters give the viewer the perception that action is taking place.

Data trend filter
Animated graphics generated are further enhanced with trend based movement.
   A trend is calculated based on the current rate of data input. A trend applied to actual data results provides a greater amount of motion to the generated animated graphics.

Data noise filter
Animated graphics generated are further enhanced with predefined movement.
   A noise is calculated based on a predefined calculation. A noise applied to actual data results provides a motion to the generated animated graphics.

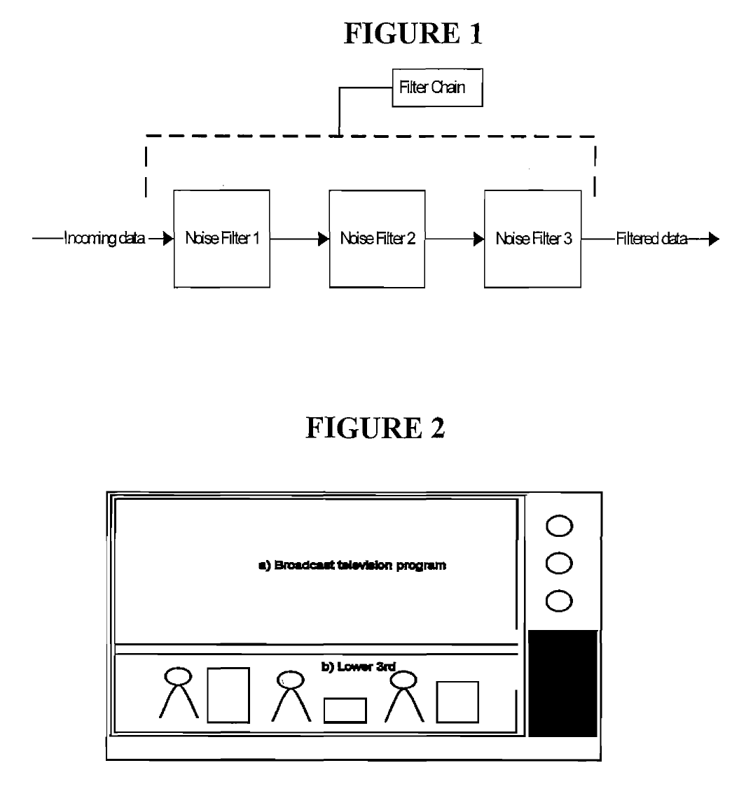

The TRS has the ability to chain together 1 or more filters on any stream of input data. Each link in the filter chain provides additional “noise” to its' incoming data. For example in FIG. 1 a chain of three filters are applied sequentially to the single stream of data.

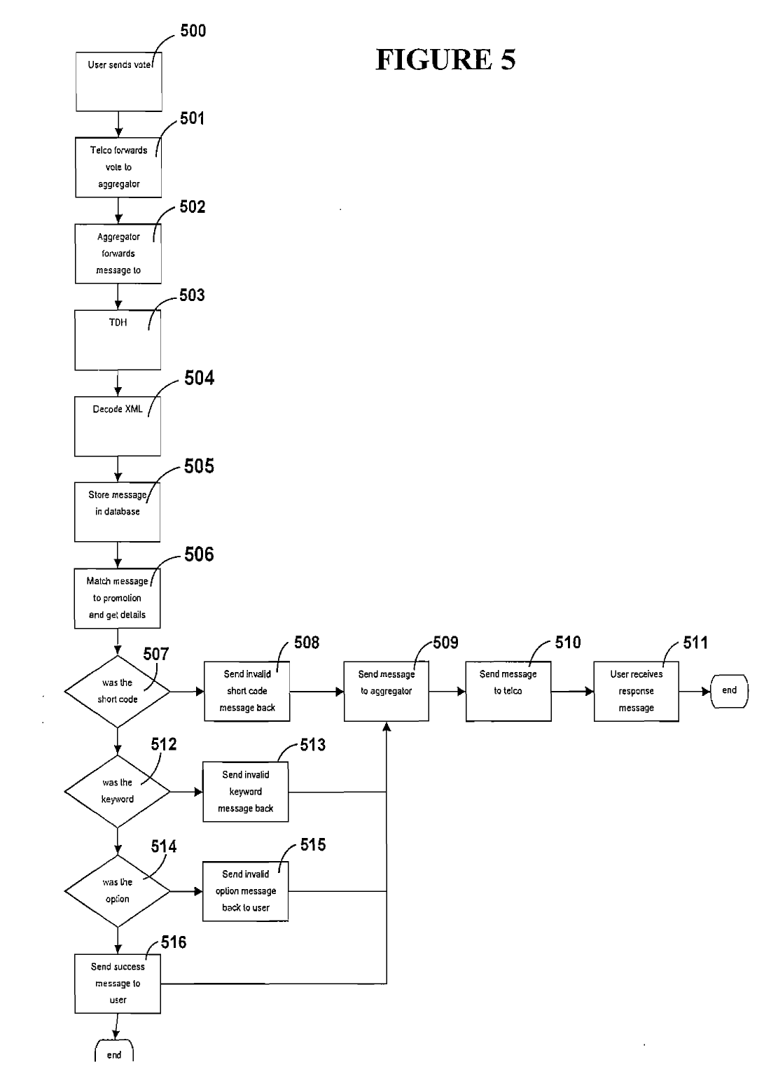

Referring to FIG. 5 the processing of text messaging for voting is shown. In step 500 a Mobile device user sends a message to a short code in response to a promotion. E.g. text ANGELS and the players number to 58629.

In step 501 the message is sent over the mobile phone network to their telco provider. The telco provider recognises the short code and forwards this message to the aggregator.

In step 502 the Aggregator system forwards messages from all telcos to the TDH. These messages can be sent using internet http post, SMPP over internet or private network, SMTP or other networking protocol

In step 503 the TDH system receives the messages and responds to the Aggregator system that it successfully received the message.

In step 504 the TDH system decodes the message into an object that is used for processing. In step 505 the TDH system stores the message into the message received table in the TDH database.

In step 506 the TDH system processes the message and matches it to the correct promotion and the correct option—this is achieved by 507, 512, 514.

In step 507 the system checks to see if the short code is correct by trying to match it against short codes defined in the systems promotion table in the database.

In step 508 the system has not found a matching short code and creates a message using a predefined response message stored in the system. This message is configurable.

In step 509 the message is sent to the Aggregator system. The message can be sent using internet http post, SMPP over internet or private network, SMTP or other networking protocol.

In step 510 the Aggregator system then sends the message to the users telco provider.

In step 511 the telco delivers the message back to the user.

In step 512 the system checks to see if the keyword is correct by trying to match it against keyword regular expressions defined in the systems promotion table in the database. The records it checks against have the correct short code. The system does not require keywords as message options can be sent direct to a short code. This is achieved by defining a regular expression that allows no keyword to be passed.

In step 513 the system has not found a matching keyword and creates a message using a predefined response message stored in the system. This message is configurable.

In step 514 the system checks to see if the option is correct by trying to match it against option regular expressions defined in the systems options table in the database. The records it checks against have the correct short code and keyword.

In step 515 the system has not found a matching option and creates a message using a predefined response message stored in the system. This message is configurable.

In step 516 the system has found a matching option and creates a message using a predefined response message stored in the system. This message is configurable.

Message Receiver

The Message receiver is an ASPX page that receives the details of the SMS that a user has sent. The details of the message will be passed as XML in a URL parameter called “SMS”. The format of this XML can be seen in Appendix A.

The Message Receiver performs the following tasks:
1. Decodes the XML to get the SMS
2. Insert the details of the message into the txt_received_msg table
3. Call the promotion manager
4. Send an SMS about the success or otherwise of the entry
5. If the entry was successful record this in the database
   Implementation: VB ASPX Page. XML parsing will be performed with a “SAX” parser. Caching: The message receiver will cache the list of promotions and promotion options. If a promotion is modified in the database it can be made to reload by modifying the web.config for the application.
   Promotions Message Processor

This component takes the details of the message that has been extracted from the XML and processes it.

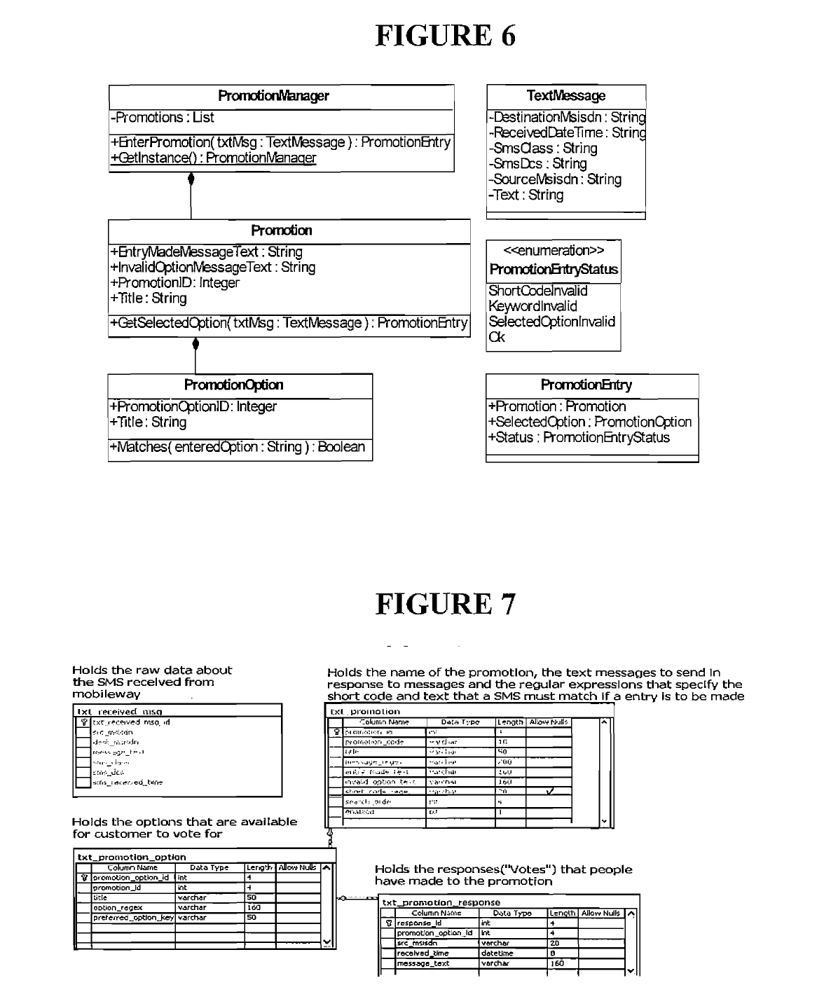

Implementation: Class Definitions defined inside VB ASPX Pages, as seen in FIG. 6

Promotion Summary XML Generator

This is an ASPX page that queries the “txt_promotion_response” table and displays the aggraded results as an XML document.

Implementation: ASPX Page and stored procedure

XML Format

<?xml version=“1.0” ?>

<IDOL> <!—The promotion code from the txt_promotion table -->
<_1> <!—Will always be one -->
<IDOLM> <!—The promotion code followed by the
preferred_option_key from the

txt_promotion_option table

-->
<percent>0.001156043</percent> <!—The percentage of the total
that votes for this option account

for -->

<total>5</total> <!—The total number of votes for this option -->

</IDOLM>

<IDOLB>
<percent>100.0037</percent>
<total>432526</total>

</IDOLB>
</_1>

10</IDOL>

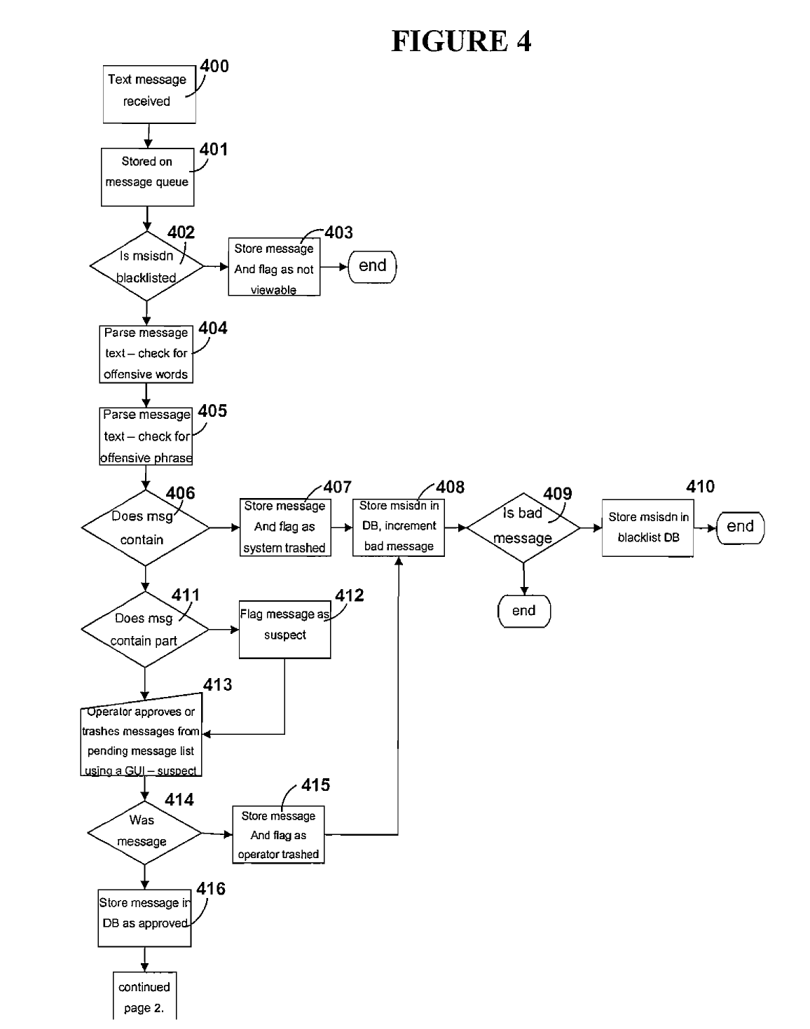

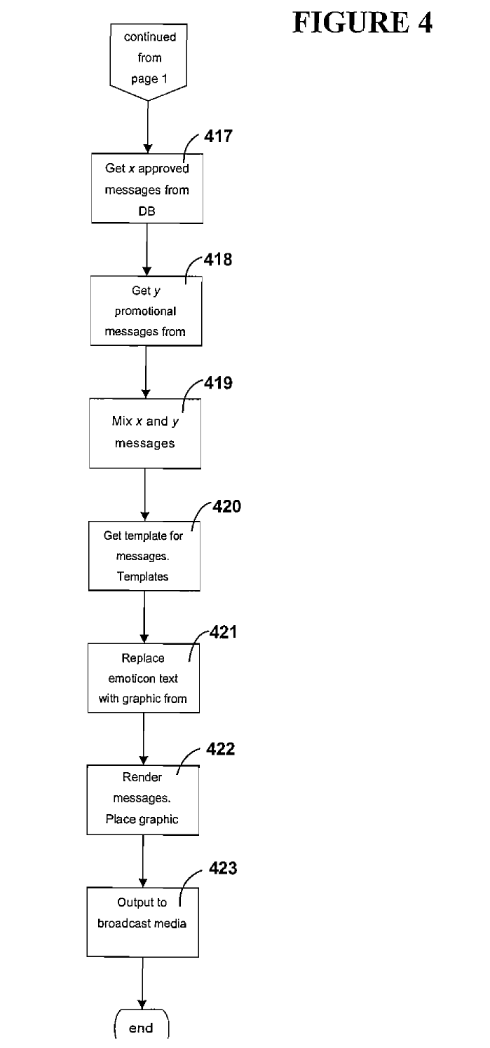

Database Schema
The database structure is shown in FIG. 4, comprised of 4 tables described below. Txt_received_msg

This table holds the raw details of the SMS that has been received from mobileway.

| Field | Purpose |
|---|---|
| txt_received_id | The unique numeric identifier of the text |
| | message |
| src_msisdn | The MSISDN of the customer that sent the |
| | message. Maps from the MSISDN element in the |
| | XML. |
| dest_msisdn | The number the customer sent the SMS to. This |
| | is mapped from the originating_address element |
| | in the XML |
| message_text | The text from the SMS |
| sms_class | Class specifies the type of short message. The |
| | possible values are 0, 1, 2 and 3. Class values |
| | are described in GSM 03.38. |
| sms_dcs | Specifies how the text of the SMS is encoded. |
| | Currently Mobileway will only be sending SMSs |
| | with DCS of “7b”. Data Coding Scheme |
| | values are specified in GSM 03.38. |
| sms_received_time | The date and time the SMS was received on |
| | mobileway's network. Will need to find out if |
| | this is GMT. |

Txt_promotion

There is an entry in this table for each promotion (each keyword)

| Field | Purpose |
|---|---|
| promotion_id | The unique numeric identifier of the promotion |
| promotion_code | A unique code for this promotion. This is used |
| | as the root tag in generated output XML |
| title | A descriptive title of the promotion. Used for |
| | administration purposes only |
| message_regex | The regular expression that the text of an SMS |
| | must match if it is for this promotion. The |
| | regular expression must be of a format |
| | supported by the |
| | System.Text.RegularExpressions.Regex class and |
| | must contain a named group called “option”. |
| | This group is extracted from the message and |
| | used to find the option that they have voted |
| | for. For example: - TEAM (?<option>[a-z\|A-Z\|]+) |
| short_code_regex | The regular expression that the destination |
| | MSISDN of the SMS must match if it is to be |
| | handled by this promotion. If this value is |
| | null then the promotion will handle messages |
| | received on any short code. If the promotion |
| | was listening for items sent to short code 888 |
| | then the field value would be “888”. |
| search_order | The order that an incoming SMS should be |
| | compared to each of the regular expressions |
| | when deciding if it is a response to this |
| | promotion. Promotions with search_order set |
| | to 0 will be tested before those set to 1. |

Txt_promotion_option

There is an entry in this table for each option for a promotion. E.g. A promotion/poll vote for your favorite fish might have the options

A—Snapper

B—Kingfish

C—Tuna

| Field | Purpose |
|---|---|
| promotion_option_id | The unique numeric identifier of the |
| | promotion option |
| promotion_id | The promotion that this option is for |
| title | A descriptive title for this option. Used |
| | for administration purposes only |
| option_regex | The regular expression that the option that |
| | user has entered must match. The value this |
| | is validated against is the value extracted |
| | using the regular expression message_regex |
| | from the promotion table |
| preferred_option_key | The text that you would instruct users to |
| | enter if they wanted to vote for this |
| | option. This is used in the generated |
| | summary XML |

Txt_Promotion_Response

Each time a user successful enters a vote it is recorded in this table.

| Field | Purpose |
|---|---|
| response_id | A unique numeric identifier of the vote |
| promotion_option_id | The promotion option that this vote is for |
| src_msisdn | The MSISDN of the user that made the |
| | response |
| message_text | The text of the message the user sent |
| received_time | The date and time the entry was inserted |
| | into the table |

Stored Procedures
Stored procedures will be used for all data access. This provides the following benefits:

Queries are precompiled leading to faster execution time

A change to the database table structure is less likely to result in a change to the code as the stored procedure can be modified instead. For example a table name changes

Queries can easily be reviewed by a DBA without having to trawl through code

| Stored Procedure Name | Purpose |
|---|---|
| txtInsertReceivedMessage | Insert the raw data |
| | received from Mobileway. |
| | Currently this is just kept |
| | for logging purposes but |
| | in the future it could be |
| | used to display a “ticker |
| | tape” |
| txtInsertPromotionEntry | Inserts an entry into the |
| | promotion that the user has |
| | selected |
| txtGetAllEnabledPromotions | Gets the details of all |
| | enabled promotions |
| txtGetAllPromotionOptionsForPromotion | Gets the details of options |
| | available for the promotion |
| txtGetPromotionResponseSummary | Gets a summary of all |
| | responses to a promotion. |
| | This is used to generate a |
| | screen showing the number |
| | of votes for each option |
| | and the percentage that |
| | votes for this option is of |
| | the total. See Appendix B |
| | for details of what this |
| | stored procedure returns. |

txtGetPromotionResponseSummary

This stored procedure returns the number of votes for each option and the percent of votes that have been made for an option. Using a stored procedure means that if it is decided that this summary information will be pre generated and stored in a summary table no changes to the code will be required.

/**
* Gets the details of the promotion with the given ID
* It returns to result sets. The first contains the promotion code
for the given id and the total number of votes that have been made
in the promotion
* The seconds result set returns the number of votes for each option
*/
CREATE PROCEDURE txtGetPromotionResponseSummary

@promotion_id int

AS
-- Get the promotion code and total votes
SELECT txt_promotion.promotion_code FROM txt_promotion WITH
(NOLOCK)
WHERE txt_promotion.promotion_id = @promotion_id
-- Get the number of votes for each option
SELECT txt_promotion_response.promotion_option_id,
txt_promotion_option.preferred_option_key,

COUNT(*) AS Votes

| FROM | txt_promotion_response WITH (NOLOCK) INNER JOIN |
|---|---|
| | txt_promotion_option WITH (NOLOCK) ON |

txt_promotion_option.promotion_option_id =
txt_promotion_response.promotion_option_id
INNER JOIN

txt_promotion WITH (NOLOCK) ON
txt_promotion.promotion_id =

txt_promotion_option.promotion_id
WHERE (txt_promotion_option.promotion_id = @promotion_id)
GROUP BY txt_promotion_response.promotion_option_id,
txt_promotion_option.preferred_option_key
GO

Database Tuning

An index has been added on the txt_promotion_response table as it halves the response time of the query that generates summary information.

Before adding index on txt_promotion_response.promotion_option_id

| SQL | Execution Time |
|---|---|
| exec txtGetPromotionResponseSummary 1 | 2 seconds with |
| | 1074079 rows in |
| | database |
| txtInsertPromotionEntry @promotionId=1, | 0 seconds with |
| @selectedOptionId = 1, @receivedDateTime = | 1074079 rows in |
| ‘1/1/2004’, | database |
| @sourceMsisdn=‘1234’,@message_text=‘rugby | |
| 1234’ | |

After adding index on txt_promotion_response.promotion_option_id

| SQL | Execution Time |
|---|---|
| exec txtGetPromotionResponseSummary 1 | 1 seconds with |
| | 1074079 rows in |
| | database |
| txtInsertPromotionEntry @promotionId=1, | 0 seconds with |
| @selectedOptionId = 1, @receivedDateTime = | 1074079 rows in |
| ‘1/1/2004’, | database |
| @sourceMsisdn=‘1234’,@message_text=‘rugby | |
| 1234’ | |

Example: Voting

The propositions (i.e. who you want to vote for) are presented on Television. Mobile device users might send their vote via sms to participate in an interactive Television broadcast. The votes can be summarized and displayed using bars, pie, histograms etc. These graphs could be mixed into the Television Broadcast.

Example: Sports Broadcast Enhancement

The proposition could be delivered by either the commentators or position screen—e.g. Which pitcher would you least like to face? Player A, Player B or Player C. Text A, B or C to 123456 (short code)

During the broadcast the results are displayed on screen mixed with the actual broadcast. In FIG. 2 the graphics are animated in the lower third of the screen (b) while the broadcast is displayed in (a).

Example: Political Poll

The political poll is a broadcast enhancement to a political debate. Mobile device users interact by sending sms messages to a short code agreeing or disagreeing to political propositions presented at different times by the broadcaster.

The “Head to Head” format provides a 3D representation of each candidate, or representative of. Each 3D representation is animated in real-time driven from the interaction from the mobile device users. For example a 3D characterization of a candidate will smile while users are agreeing, the opposing 3D character will be frowning.

The animated graphics are provided in a lower 3^{rd} graphic to be mixed into the political broadcast.

Geographic Mapping

Mobile device users will send a geographic code with their vote/poll by using either their state (e.g. Calif.) or zip code or other. Alternatively the location could be determined either by the mobile phone number or supplied by the provider. Real-time animated graphics are generated by geographical area. This will display results by geographic region.

TXT Messages to Screen

A further embodiment of the present invention is ticker/scroller displaying received txt messages directing on the graphic. For example with an average sized font running at an easily readable speed could display up to 375 average length messages per hour. This also means that 375 times an hour you would have a logo/bullet between each scrolling message. The speed, look and feel can be modified and add multiple tickers/scrollers if necessary or desirable. The capacity will increase if you increase the scrolling speed of the messages.

Referring to FIG. 4 the processing of text messages for display is shown. In step 400 a list of text messages is received by the TRS from the TDH in an XML formatted document. The messages within this document have been sent to the TDH in response to promotional material, in the form of on screen graphics (television, stadium graphics), television commentators, or in print i.e. a flyer, or advertisement.

The messages received are delivered in response to the TRS sending an HTTP request to the TDH. This request uses URL parameters to determine the start message number, the number of messages to return and the promotion code.

Each message in the TDH has a unique number associated with it. This number is auto incremented for each message as the TDH receives it.

Each message has the following information associated with it;

Message id: the unique message number

Date Time sent: The date and time the message was sent from the mobile

Msisdn: The msisdn that sent the message.

Text: The text that was sent by the mobile device user.

### Example

<message>

<message_id>130650</message_id>
<date_time_sent>2003-01-16 2:30:09</date_time_sent>
<msisdn>6421234567</msisdn>
<text>I love big day out!</text>

</message>

In step 401 the system breaks down the list of messages received to each message. Each message is stored in the database on the TRS in the pending message table.

Each message is identified as a new message i.e. one that has had no processing on it.

In step 402 the system checks each messages msisdn against a black list. A black list is a list of msisdns that are blocked i.e. not able to participate in the promotion.

In step 403 if an incoming message is from a black listed msisdn, then the message is flagged as trashed because of blacklisting and is updated in the pending message table within the database. Trashed messages are never available to be used in the system.

In step 404 the system checks for words that are offensive. The system uses a list stored in the systems database of offensive words.

In step 405 the system checks for phrases that are offensive. The system uses a list stored in the systems database of offensive phrases.

In step 406 the system decides whether the message has passed the offensive language check.

In step 407 if an incoming message is from a black listed msisdn, then the message is flagged as trashed because of offensive language by the system and is moved into the processed message table. Trashed messages are never available to be used in the system.

In step 408 the system then either adds the msisdn to the blacklist in a pending state or increments a bad message counter against the msisdn since it has been previously added.

In step 409 the system checks if the pending blacklist msisdn, that has had its bad message counter incremented (in 408), has exceeded the bad message limit. The bad message limit is defined as a system parameter, and can be configured to be any number.

In step 410 the system flags the pending blacklist msisdn as blocked in the database.

In step 411 the system checks for words or phrases that are similar or contain offensive language within the text of the message e.g. if “ass” was in the offensive wordlist then “class” would be treated as suspect.

In step 412 the system flags the pending message as suspect and updates the pending message table in the database.

In step 413 the system lists all pending messages on the operators console via the systems GUI. Messages flagged as suspect are highlighted to ensure the operator notices suspect messages.

The operator manually moderates the messages. The operator must either approve or trash each message.

In step 414 the system processes the operators input and checks if the message was trashed.

In step 415 the message is moved into the processed message table in the database and is flagged as operator trashed. The system also records against the message which operator trashed the message and the time it was trashed.

In step 416 the system moves the message into the processed message table in the database and is flagged as approved. The system also records against the message which operator approved the message and the time it was approved.

In step 417 the system gets x approved messages from the processed message table within the database. Where x is a system configurable parameter.

In step 418 the system gets y promotional messages from the promotional message table within the database. Where y is a system configurable parameter.

The promotional message table contains predefined messages that are used for promotional messages. This table is maintained by the operator through the system's GUI. Promotional messages can contain messages from a sponsor, promoter or used by stadium personnel as a silent PA e.g. “would the parents of John Doe aged 7 please report to the stadium management desk”.

In step 419 the system mixes the x and y messages into a combined list of messages.

In step 420 the system gets a message template from the database that defines the look and feel of how the messages will be displayed i.e. the size, font, color, background etc.

The templates are defined per promotion by the operator. These templates are stored in the database.

In step 421 the system looks for emoticons that a user can place in their message to enhance the presentation of their message. Examples of text emoticons are: :) ;) :( : {).

The system identifies emoticons by looking for text within the message that matches text from a list of predefined text emoticons stored in the emoticons table within the database.

If the system finds an emoticon match it breaks the text of the message at the point of the emoticon, renders each piece of text using the template. The text emoticon is replaced by a graphic defined by location and name within the emoticons table. The system then reassembles the message as a rendered graphic, including the emoticon graphic.

In step 422 the rendered messages are then assembled together by the system separated by promotional graphics. The promotional graphics are stored in the database and are weighted. The weighting provides the system with a method of displaying a particular graphic more often than another.

The system can be configured to display certain graphics at certain times or message intervals or randomly picked from a list. Graphics picked randomly will favor graphics with a higher weighting.

In step 423 the final rendered messages graphic is then output to the broadcast mixer to be over laid onto their broadcast (a), for example placed as a lower third (b) in FIG. 2.

Graphic Shape

Full-screen
Lower 3^{rd}/Baseline
“L” shaped
or any custom shape with transparency to show video through
   Graphic Content

Copy & Instructional Text

Dynamic Voting Elements

Dynamic Message Ticker/Scroller

Sponsor Logos

Other Decorative Graphical Elements

Background Elements

Still images with or without transparency

Looping Animations or Animated sequences—to be used to create a shimmering effect or interesting background effect but also to be used to animate Copy & Instructional Text as well when screen space is limited—NOTE: these are looping animations which are pre-rendered and timing is always pre-determined and not changeable during the event

Dynamic Data Driven Elements—can have feeds attached to them to determine what data is displayed. They can also have data filters attached to the feeds to modify the Data as it comes in—e.g. Smooth Animation Interpolation, Trend Analysis, Noise, or Exaggeration
Text (e.g. Names etc)
Numbers (e.g. Percentages or other Values)
Horizontal or Vertical Bars
Can be Colored or Textured with an image
Looping non-data-driven Animations (e.g. Baseball Spinning or Rugby guy running)
Images (e.g. Player pictures or Voting Contestants etc)
Animation Sequences (e.g. Speedometers, Morphing heads, or anything etc)
Message Ticker/Scroller (optional)—can be any Windows font (Truetype TTF) with a predetermined style per Graphic
Customer Messages (with picture Emoticons)
Promotional/Advertising Messages (with picture Logos)
   Quality Control

TXT messages to screen for the ticker/scroller can include an Approval/Filtering System which has features such as:
A MANUAL operator-based service to ONLY allow messages to air that have been approved by an operator.
All messages will be archived as to whether they are played, or trashed and when that occurs and who approved what messages to air.
Automatic trashing of messages containing the full words of bad/swear-words or brand names in our Word Filter list (which is adjustable) and currently contains over 400 bad words and/or permutations of those words.
Red highlighting of suspected bad words, i.e. messages with the word “Assignment” might get flagged for further close examination because it contains the word “Ass” for example.
Messages can be approved one at a time—but if more than 10 messages are sent for approval the system confirms this before sending it through as a back up measure to avoid human error.
One-off hand typed messages can be added to the approval queue from the consol without having to actually txt in.
Instant-Message type (Yahoo/MSN) Icons are available in all message-tickers/scrollers for keywords or symbols such as:-)
Previously played or trashed messages can be recycled for re-approval or re-playing to screen.
A Blacklisting system is in place which counts the number of times that a viewer from a particular phone number TXTs in with a swear-word from our Word-Filter list—the system can be set to automatically blacklist all messages from that phone number if say the user sends in a specific number (say two or three) of messages with bad words. This means any subsequent message that the view sends in will be automatically trashed—this weeds out abusive people from the mix. Numbers can be manually added or deleted to the Blacklist as well.

What is claimed is:

1. A media delivery system comprising:
an input configured to receive a video signal;
at least one data input configured to receive raw data received from a public communications system;
a processor configured to receive said raw data and said video signal and:
filter said raw data according to predetermined instructions,
calculate statistics relating to said filtered data in real time at least over periods
short enough to approximate real time, and
generate a composite signal, having a portion composed of said video signal and a portion comprising a real time graphical representation of at least one of said statistics;
an output configured to provide said composite signal.
